(19) United States
(12) Patent Application Publication
(10) Pub. No.: US 2025/0026456 A1
(43) Pub. Date: Jan. 23, 2025

(54) TRANSPORT AND TOWING DEVICE FOR A KAYAK, CANOE, OR SMALL WATERCRAFT

(71) Applicant: Ian Rosenbaum, Wilmington, NC (US)

(72) Inventor: Ian Rosenbaum, Wilmington, NC (US)

(21) Appl. No.: 18/764,991

(22) Filed: Jul. 5, 2024

Related U.S. Application Data
(60) Provisional application No. 63/527,514, filed on Jul. 18, 2023.

(51) Int. Cl. B63B 34/63; B62B 5/00; B63B 34/67

(52) U.S. Cl. CPC B63B 34/63; B62B 5/0033; B62B 5/0086; B63B 34/67

(57) ABSTRACT

The invention is a transport device that used in conjunction with a kayak cart or other similar apparatus supporting one end of a kayak. The transport device enables the entire weight of the kayak to be supported by the two devices working in tandem. The user only needs to provide enough force to tow the kayak and is not required to support its weight and the weight of any items loaded onto the kayak. The user can therefore easily and efficiently transport a kayak and its contents over varied terrain from a first location to a second location.

### CROSS-REFERENCE TO RELATED APPLICATIONS

This application claims priority to U.S. Provisional Patent Application No. 63/527,514, filed Jul. 18, 2024, the entire content of which is hereby incorporated by reference.

### FIELD OF THE INVENTION

The present invention relates to a transport and towing device that can be used with conveying a kayak, canoe, small watercraft, and/or other item over land from a first location to a second location.

### BACKGROUND

Kayaking is a popular water sport and recreational activity enjoyed by enthusiasts worldwide. However, manually transporting kayaks over land to and from the water's edge or from a first location to a second location can be tiresome and challenging. As a result, numerous kayak transport devices have been developed to facilitate the transportation of kayaks and other small watercraft across different types of terrain. For example, there are numerous types of carts, dollies, and other similar devices that are conventionally used to manually transport a kayak.

These devices generally fall into three categories. The first category employs two wheels to support a limited portion of the weight of the kayak. These devices can when properly positioned support the entire weight of a kayak, however in general use they are often employed towards one end the kayak and when so employed do not support the entire weight of the kayak. Specifically, a device is positioned under one end of the kayak (usually towards the stern aft section of the hull), such that the kayak rests on the device. The kayak is then secured to the device using straps or other similar items. Accordingly, a user must manually support a portion of the weight of the kayak by lifting, towing, and steering using a handle at the front bow section of the watercraft.

The second category of transport carts and dollies includes devices that comprise two wheels and a frame that is inserted into the scupper holes of a kayak. A scupper is an opening in the sidewalls of a vessel that allows water to drain instead of pooling within the vessel interior. Although no straps are required, the transport device can only be utilized at the location of the scupper holes. As a result, the device is prevented from being placed in locations that would balance the load of the kayak. Further, the transport devices are typically positioned at the stern aft section of the kayak hull, requiring the user to manually support a portion of the weight by lifting, towing, and steering via a handle.

The third category of transport carts and dollies includes devices that comprise two wheels that are permanently attached to the deck of a kayak. These devices are generally used on heavy fishing kayaks and are installed behind the seating area of the user. As a result, these devices are prevented from being placed in locations that would balance the load of the kayak since when in use the wheels of these devices are typically positioned towards the stern aft section of the kayak, requiring the user to manually support a portion of the weight by lifting, towing, and steering via a handle at the front of the craft.

Thus, prior art transport devices do not support the full weight of the kayak and associated gear being transported. Further, conventional transport devices require the user to support a large portion of the weight of the kayak and associated gear using their body. As a result, moving a kayak using prior art transport devices can be both tiresome and difficult especially when larger distances are traversed.

It would therefore be beneficial to provide a kayak transport device that allows a user to easily and effectively manually transport a kayak over short and moderate distances of varied terrain. It would further be beneficial to provide a kayak transport device that allows the full weight of the kayak and its contents to be supported by the transport device.

### SUMMARY

The present invention solves multiple problems related to manually transporting a kayak. By providing a device to support the weight of one end of a kayak, when used in conjunction with wheels or another device attached elsewhere to the kayak, a single user can easily transport, tow, and steer a kayak from one point to another with minimal effort.

None of the prior art or existing patents teach or disclose a kayak transport device having the means to support the weight of one end of a kayak by removably connecting and suspending said end of the watercraft to a mounting point above a pair of wheels that can be controlled by the user as is shown in the present invention.

Accordingly, it is an object of the present invention to provide a device for transporting a kayak over land which allows the entire weight of the kayak and its contents to be supported while simultaneously allowing the kayak to be easily moved and steered by a single user over varied terrain.

Additional objects of the present invention also include providing a device that allows for a kayak, canoe, or other small watercraft to have one of its ends supported by the device (most usually this will be the bow of the craft). A kayak handle can be easily attached and removed from the device. The connection point of the device to the kayak can be configured to swivel to allow easy maneuverability and steering by the user of the device. The transport device is adjustable for use with various sizes and configurations of kayaks and their handles and/or suspension points. The disclosed transport device can be disassembled and/or is collapsible for easy storage. The transport device is durable, lightweight, and easy to use. The device further can be economically manufactured and is affordable to the user.

In accordance with the present invention, there is provided a kayak transport device for transporting an item. In some embodiments, the item can be a kayak comprising another cart/apparatus with wheels attached towards one end of the kayak opposite to the attachment point of the kayak to the device of the present invention. The device includes at least two wheels connected by an axle, a frame that supports an anchoring point above the wheels from which a kayak may be suspended by its carrying handle and that connects to a device handle that can be held by the user to tow and steer the device.

In some embodiments, when the transport device is at rest the weight of the kayak is supported between the frame and wheels and when the second end of the frame is manually raised, the weight is supported only by the wheels.

In some embodiments, the presently disclosed subject matter is directed to a transport device. The transport device includes a frame defined by a first end and a second end and a length therebetween. The first frame end is attached to an axle that connects to at least two wheels and the second frame end is attached to a handle. The device includes a first leg comprising a first end and an opposed second end. The device comprises a second leg comprising a first end and an opposed second end. The device includes an anchor point defined by an attachment configured to releasably attach to an item to be transported. The device comprises a support comprising a first end and a second end, the support positioned along the length of the frame, between the first leg and the handle. The first end of the first leg is attached to the frame along the length of the frame and the second end of the first leg is attached to the first end of the second leg. The anchor point is positioned adjacent to the second end of the second leg. In some embodiments, the first leg and second leg can be joined as a single unit (e.g., one leg is bent relative to the other leg). In other embodiments, the first and second legs are each a separate element.

In some embodiments, the length of the frame is adjustable. For example, the frame can have length (e.g., the distance between the first and second ends of the frame) of about 20-100 inches (e.g., at least/no more than about 20, 30, 40, 50, 60, 70, 80, 90, or 100 inches). However, the presently disclosed subject matter is not limited and can be configured with a length outside the noted range.

In some embodiments, the frame comprises a top face and an opposed bottom face, and wherein the first end of the first leg is attached to the top face and the support is attached to the bottom face.

In some embodiments, the support is rotatable between a first position that extends in a downward direction and a second position parallel with or contacting the bottom face of the frame. The term “rotatable” refers to a capability for a rotational movement around an axis.

In some embodiments, the first end of the first leg is attached to the frame at an angle, and wherein the angle is adjustable between 40-100 degrees.

In some embodiments, the first end of the first leg is attached to the frame at an angle of 60 degrees.

In some embodiments, the anchor point is configured to swivel.

In some embodiments, the positions of the first arm and second arm are configured to fold parallel with the frame. The term “parallel” refers to deviating less than 20, 10, 5, or 1 degree from parallel alignment.

In some embodiments, the anchor point is aligned between the first end of the first leg and the axle in a first at rest orientation and the anchor point is aligned over the axle in a second in use orientation.

In some embodiments, the handle is elevated in the second in use orientation.

In some embodiments, the at least two wheels are powered by a battery and motor.

In some embodiments, the presently disclosed subject matter is directed to a method of transporting an item having a weight using the disclosed transport device. Particularly, the method comprises positioning a first end of the item on a foundation comprising at least one wheel, wherein the foundation supports a weight of the first end of the item. The method includes attaching a second end of the item via an attachment point or item handle to the anchor point via the attachment as a first orientation. The method includes elevating the handle, wherein the weight of the item is distributed over the transport device two or more wheels, foundation one or more wheels, and the frame in a second orientation. The item is transported from a first location to a second location using a pulling or pushing action by a user.

In some embodiments, the item is selected from a kayak, a canoe, or a watercraft.

In some embodiments, 100% of the weight of the item is distributed over the transport device two or more wheels, foundation one or more wheels, and frame.

### BRIEF DESCRIPTION OF THE DRAWINGS

Further objects, features and advantages of the present invention will become apparent upon the consideration of the following detailed description of varied embodiments when taken in conjunction with the accompanying Figures.

FIG. 1a is a perspective view of a transport device in accordance with some embodiments of the presently disclosed subject matter.

FIG. 1b is a side plan view of a transport device in accordance with some embodiments of the presently disclosed subject matter.

FIG. 2 is a perspective view of a device handle in accordance with some embodiments of the presently disclosed subject matter.

FIG. 3 is a side plan view of a device anchoring point and a kayak suspension point in accordance with some embodiments of the presently disclosed subject matter.

FIG. 4a is a side plan view of a transport device attached to a kayak at rest in accordance with some embodiments of the presently disclosed subject matter.

FIG. 4b is a perspective view of a transport device attached to a kayak at rest in accordance with some embodiments of the presently disclosed subject matter.

FIG. 4c is fragmentary perspective view of a transport device attached to a kayak at rest in accordance with some embodiments of the presently disclosed subject matter.

FIG. 5a is a side plan view of a transport device attached to a kayak during transport in accordance with some embodiments of the presently disclosed subject matter.

FIG. 5b is a perspective view of a transport device attached to a kayak during transport in accordance with some embodiments of the presently disclosed subject matter.

FIG. 6 is a fragmentary view of a transport device first and second arms in accordance with some embodiments of the presently disclosed subject matter.

FIG. 7 is an exploded view of a transport device in accordance with some embodiments of the presently disclosed subject matter.

FIG. 8 is a perspective view of a transport device in a folded storage orientation in accordance with some embodiments of the presently disclosed subject matter.

### DETAILED DESCRIPTION

The disclosed kayak transport device and its component parts of the preferred embodiments of the present invention are represented in detail by the Figures described above.

The presently disclosed subject matter is directed to a transport device that can be used to quickly and easily move a kayak or other large item from a first location to a second location. While the instant disclosure discusses use of the transport device primarily with kayaks, it should be appreciated that the presently disclosed subject matter is not limited and the transport device can be used to transport a wide variety of items, such as (but not limited to) canoes, paddleboards, and other small watercraft. The term “kayak” refers to any hollow-form, elongated, decked boat that a person can sit on or sit in and propel by hand-paddles, foot drives, and/or pedals that power a propeller or fins. The term “canoe” refers to any lightweight narrow water vessel, typically pointed at both ends and open on top, propelled by one or more seated or kneeling paddlers facing the direction of travel and using paddles. The term “paddleboard” refers to any large surfboard like floatation device that can be propelled by a user with a paddle in a standing, kneeling, or seated position. The term “watercraft” refers to any vehicle capable of traveling on or under water whether or not the vehicle is motorized.

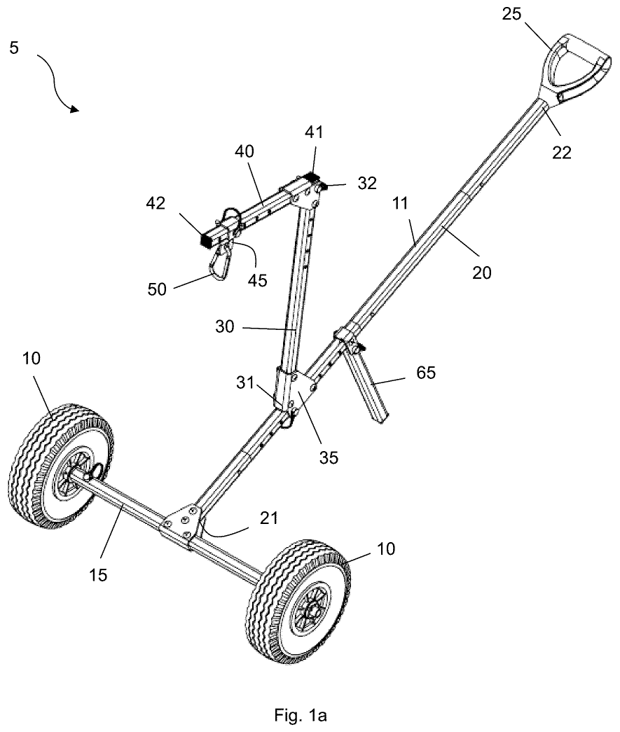

As illustrated in FIGS. 1a and 1b, transport device 5 includes two or more wheels 10. The wheels can be connected by axle 15 that acts as a central shaft for the rotating wheels. Thus, the axle can be fixed to the wheels, rotating with them or fixed to the remainder of the transport device, with the wheels rotating around the axle. The term “wheel” includes any mobility element that can be used to contact a surface and provide motion of device 5. For example, a wheel can be a circular element that rotates about an axis.

In some embodiments, the axle can be perpendicularly connected to frame 20. The frame includes first end 21 positioned adjacent to axle 15. The frame also includes opposed second end 22 positioned directly adjacent to handle 25 that can be grasped by the user to lift and/or maneuver the transport device. The term “frame” broadly refers to a portion of the disclosed transport device suited to have a structural function.

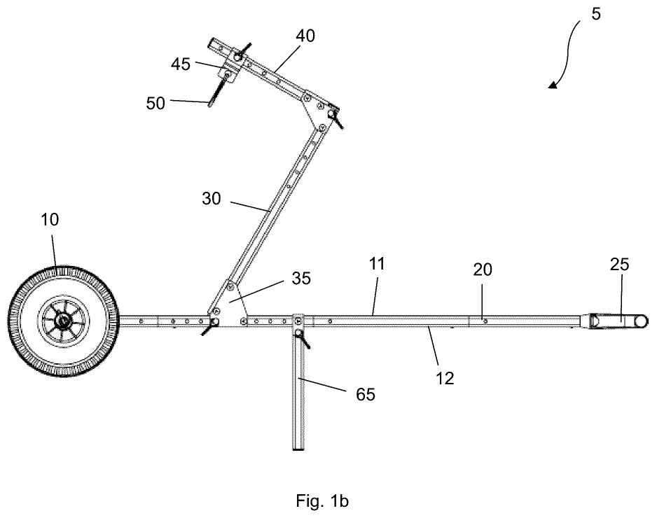

FIG. 2 illustrates one embodiment of handle 25 comprising grip 26 that can be easily grasped by a user's hand. The handle also includes shaft 27 that connects with second end 22 of the frame using any conventional method (e.g., telescoping). It should be appreciated that handle 25 is not limited to the embodiment illustrated in FIG. 2. Rather, the term “handle” broadly refers to any member that can be manually gripped or held to lift and/or move transport device 5.

Handle 25 can be configured as a separate element that is removably or permanently attached to the frame. Alternatively, the handle can be constructed at second end 22 of the frame using a standard molding or bending mechanism as would be known in the art.

As shown, first arm 30 extends upward and away from the frame, attached to top face 11. The top face of the frame is the face that is facing upwards (e.g., the sky) when the frame is in a horizontal orientation. The frame also includes opposed bottom face 12 that faces downwards (e.g., the floor) when the frame is in a horizontal orientation.

The first arm includes first end 31 that directly contacts and is attached to frame 20. The first arm can be attached to the frame using any method, such as the use of welding and/or mechanical elements (e.g., screws, clips, bolts, fasteners, plastic or metal plates/brackets, and the like). In some embodiments, the frame and/or arms can include optional brace 35 to increase stability. Opposed second end 32 of the first arm is attached to second arm 40 using conventional methods (e.g., welding, mechanical closures).

The first arm can include a length (e.g., the distance between ends 31, 32) of about 10-50 inches (e.g., at least/no more than about 10, 20, 30, 40, or 50 inches). However, the length of the first arm is not limited to the range given herein.

The second arm includes first end 41 that attaches to the second end of the first arm. The second arm also includes second end 42. The second arm extends out and is positioned over wheels 10 (e.g., above the center point of the axle between the wheels) or over the length of the frame, depending on whether the transport device is in use or at rest, as discussed below.

Second arm 40 provides anchoring point 45 positioned adjacent to the second end of the second arm, as illustrated. In some embodiments, the anchoring point can be positioned about 1-20 inches from second end 42 (e.g., at least/no more than about 1, 5, 10, 15, or 20 inches).

The second arm can have a length (e.g., the distance between ends 41, 42) of about 5-50 inches (e.g., at least/no more than about 5, 10, 15, 20, 25, 30, 35, 40, 45, or 50 inches).

The anchoring point provides an attachment to the associated kayak, as discussed below. In some embodiments, the anchoring point can be moved forward or backward on frame 20 by constructing the second arm in two parts that allow it to be extended or retracted by utilizing any suitable mechanism.

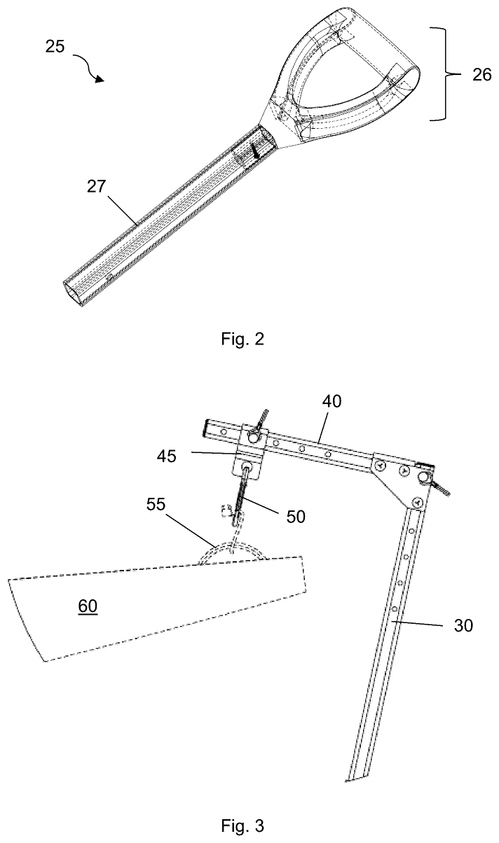

In some embodiments, attachment 50 can be permanently or releasably joined to the anchoring point (e.g., fitting through an aperture in the anchoring point). Any attachment member can be used, such as (but not limited to) a carabiner, clip, fastener, link, clasp, tie, toggle, and the like. The attachment can be utilized to suspend a kayak or other large item to be moved from a first location to a second location. Specifically, the kayak can be suspended by connecting attachment 50 directly or indirectly (i.e., to a handle via a piece of webbing or a metal ring attached to the anchor point of the kayak) to a suspension point or carrying handle of a kayak. The “suspension point” of a kayak or other item to be moved is the element upon which the item can be lifted or can hang. FIG. 3 illustrates one embodiment of suspension point 55 of kayak 60 suspended from attachment 50. The attachment can be constructed from any suitable material, such as metal, cordage, nylon webbing, and the like. The attachment can be used to connect the kayak's anchoring point 55 or the kayak carrying handle to the anchoring point of the transport device.

In some embodiments, the anchoring point can be configured as an eye bolt that is attached through second arm 40 and utilizing one or more washers on either or both sides of the second arm, secured by a lock nut. Such a configuration allows the eye bolt to swivel and aids in the maneuverability of the transport device. Thus, the anchoring point can be configured with any suitable element that allows the attached kayak to swivel and move while it is attached to the device, aiding in stability. The term “swivel” refers to a coupling between two parts enabling one to revolve without turning the other or to a mechanical element providing such a coupling. For example, a swivel can be a fastening device that allows the element fastened (e.g., kayak) to turn around freely upon it. Any type of eye bolt can be used, such as an open or closed eyebolt. For example, if the anchoring point is configured as an open eyebolt, a clip can be suspended from the open eye bolt. Alternatively, the handle of the kayak can be attached directly to the open eye bolt without the need for a clip.

The term “eye bolt” refers to a bolt configured with a loop at use end, used to attach a securing eye to a structure. Further, the anchoring point is not limited to including an eyebolt and any type of bolt or connector can be used.

The transport device also includes support 65 attached to the bottom face of the frame, as shown in FIGS. 1a and 1b. The support allows the transport device to stand upright on it and the two wheels 10. Thus, the support can rest upon a surface (such as the ground) to bear the weight of the kayak, and to balance the device on the wheels. As a result, anchoring point 45 is raised above the wheels and between the point where the wheels and the support contact the ground when the device is not in use or at rest (e.g., a user is not grasping the handle).

The support can have any suitable length, such as a distance of about 5-50 inches (e.g., at least/no more than about 5, 10, 15, 20, 25, 30, 35, 40, 45, or 50 inches). The distance of the support is the distance between first and second ends 66, 67 of the support.

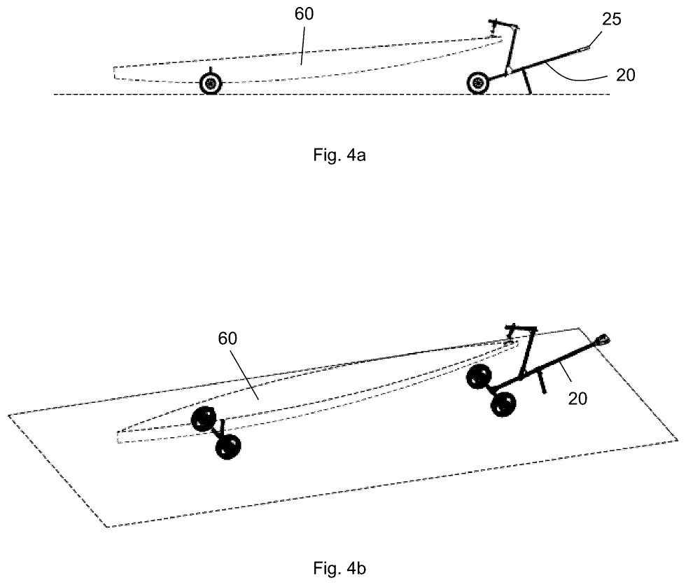

As shown in FIGS. 4a-4c, when the transport device is at rest (e.g., not being used to transport a kayak), the center of gravity of any load suspended on the anchoring point is not positioned directly over wheels 10 and axle 15. Instead, the center of gravity of the load (e.g., kayak 60) is positioned over frame 20 towards the handle (e.g., between the attachment of the support and the handle). As a result, the transport device remains stable when a load is applied to the anchoring point.

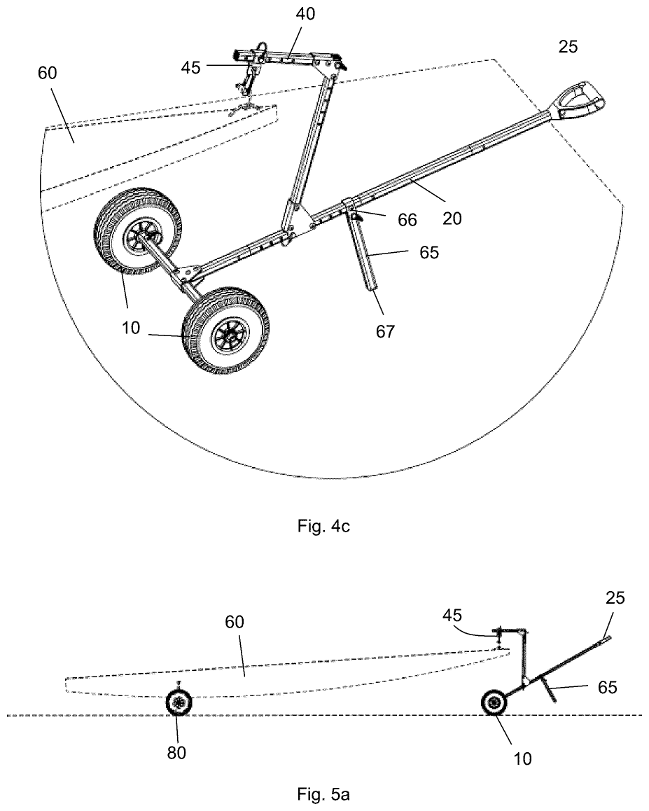

In use, the transport device handle is raised up from its resting position by a lifting action by the user, thereby removing the weight being supported from the ground by stand 65. In some embodiments, the handle can be lifted vertically a distance of about 5-100 inches (e.g., at least/no more than about 5, 10, 15, 20, 25, 30, 35, 40, 45, 50, 55, 60, 65, 70, 75, 80, 85, 90, 95, or 100 inches). The weight is transferred from anchoring point 45 to wheels 10 and the center of gravity of the kayak then moves to become predominately centered over the wheels and axle 15, as shown in FIGS. 5a and 5b.

To increase the stability of the kayak during transport, anchoring point 45 can be positioned as close to the ground as possible, while still allowing for clearances around the end of the kayak being moved. Thus, connections between the frame, first arm, and second arm can be adjustable in some embodiments. Such adjustability allows anchoring point 45 to be positioned properly by the user to provide the greatest stability when using transport device 5 with an associated kayak.

Transport device and each of the components can be constructed from any suitable material. For example, the materials selected can be strong, lightweight, durable, and corrosion resistant. The term “strong” refers to the characteristic of being resistant to damage, allowing the device to be used over a long period of time. The term “lightweight” refers to the ability of the transport device to be lifted and carried by as few as a single person. The term “durable” refers to the characteristic of resisting wear, decay, and the like. The term “corrosion resistant” refers to the ability of the material to resist deterioration caused by exposure to the environment.

Suitable materials can include (but are not limited to) steel, stainless steel, copper, aluminum, fiberglass, carbon fiber, plastic, wood, or combinations thereof. The materials can be solid or hollow.

In some embodiments, the transport device can be easily and quickly assembled and disassembled for transport and storage. For example, the frame first arm, wheels, axel, handle, support, and/or second arm can be attached and separated on demand.

In some embodiments, the connection between first arm 30 and second arm 40 is adjustable, allowing the second arm to be raised or lowered on the first arm to accommodate the different hull and handle designs of varied kayaks. Any mechanism can be used to adjust the length of the first and/or second arms, such as a telescoping arrangement, where sliding one member relative to the other enables adjusting of length. The telescoping arrangement can include a locking mechanism used to prevent the elements from sliding relative to each other when a desired length is reached.

Similarly, in some embodiments, the connection between first arm 30 and frame 20 can be adjustable, allowing the first arm to be moved forward or backward along the length of the frame (e.g., toward or away from handle 25) to accommodate the different hull and handle designs of varied kayaks.

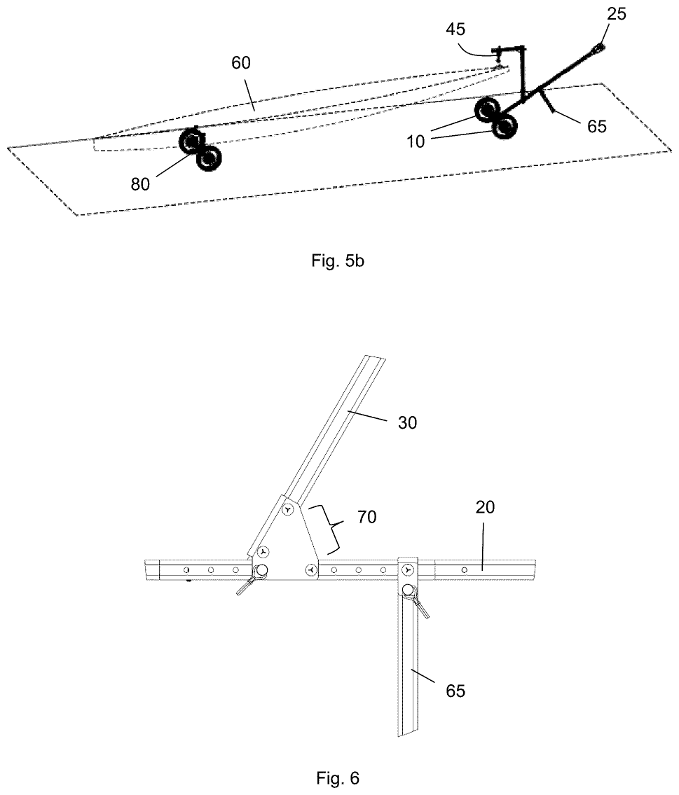

Further, the angle of connection 70 between the first arm and the frame can be adjusted, as shown in FIG. 6. For example, angle 70 can be about 60 degrees in some embodiments (e.g. at least/no more than about 40, 50, 60, 70, 80, 90, or 100 degrees). The angle can be adjusted as desired (e.g., to at least about/no more than about 40, 50, 60, 70, 80, 90, or 100 degrees).

Similarly, frame 20 can be adjusted in length in some embodiments between first and second ends 21 and 22. In this way, any of a wide variety of users can use the transport device.

In some embodiments, the frame between the first arm and the handle may be adjusted by providing a mechanism to allow frame 20 to bend up or down at an angle prior to the handle of the device to accommodate users of different heights and the distance the handle needs to be raised or lowered to use the device. This angle can be adjusted as desired (e.g., to at least about/no more than about 5, 10, 15, 20, 30, 40, or 50 degrees) by utilizing mechanisms known in the art.

Support 65 can also be positioned at any location along the length of the frame. In some embodiments, the connection between the frame and support 65 allows the support to be utilized as a kickstand and also be folded back onto the frame (e.g., parallel with and/or contacting and aligning with the frame).

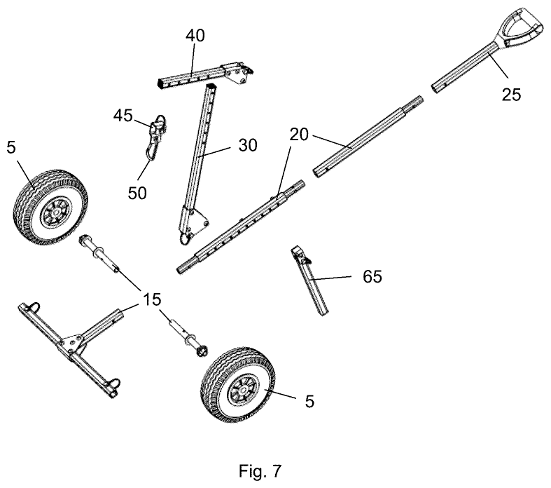

FIG. 7 is an exploded view of transport device 5, illustrating the different elements and the adjustability of the first arm, second arm, and the frame.

In operating the disclosed transport device, a user can attach a standard cart or dolly 80 according to its usage instructions to one end of the kayak being moved by the user. The second end of the kayak can then be raised, attaching the handle of the kayak or kayak suspension point 55 to anchoring point 45 (e.g., via attachment 50). Alternatively, the user may raise handle 25 higher into the air, thereby allowing attachment 50 to be connected to the handle of the kayak or kayak suspension point 55 while kayak end is on the ground. The handle can be lowered once connected to elevate the attached end of the kayak so that its weight is supported by anchoring point 45. Once the kayak is connected and the transport device is stable on the ground with the load being distributed over the wheels and the frame, the user simply raises handle 25 and can begin towing the kayak to a desired location.

Once the user reaches the second destination, handle 25 can be lowered so that support 65 rests on the ground. The kayak can be detached by uncoupling the attachment. The user may alternatively raise handle 25 higher into the air, thereby allowing the kayak to rest on the ground and then remove the kayak from the transport device via the attachment. The user can remove the cart or dolly per usage instructions and launch the kayak either before or after detaching the kayak from transport device 5.

The disclosed transport device provides many advantages over prior art transport systems. For example, transport device 5 allows the entire weight of the kayak and its contents to be supported while simultaneously allowing the kayak to be easily moved and steered by a single user over varied terrain. Thus, the user bears no weight of the kayak and associated contents.

Further, the connection point of the disclosed transport device allows the kayak to swivel, allowing for easy maneuverability and steering by the user.

The disclosed transport device is easy to use, such that users of all ages and sizes can enjoy the device.

The disclosed transport device is adjustable for use with kayaks of various sizes and configurations.

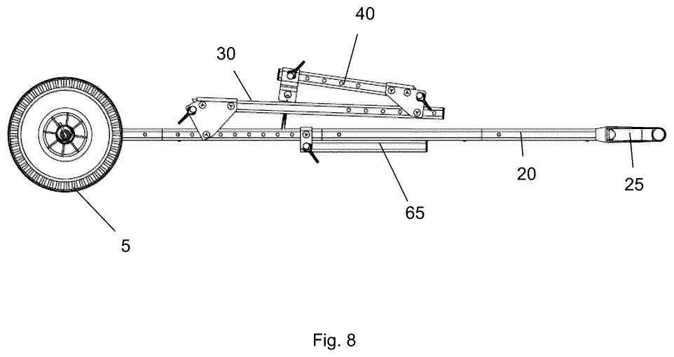

Continuing, the disclosed transport device can be disassembled and/or is collapsible for easy storage, as shown in the embodiment of FIG. 8.

The disclosed device is durable and lightweight, allowing for easy transport and use over an extended period of time.

The disclosed device can be economically manufactured and is affordable to the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A transport device comprising:
a frame defined by a first end, a second end, and a length therebetween;
wherein the first end is attached to at least one axle that connects to at least two wheels;
wherein the frame comprises a third end that provides an anchor point defined by an attachment configured to releasably attach an item to be transported;
wherein the anchor point allows a weight of the item to be transported to be suspended above the at least two wheels;
wherein the transport device has a weight; and
wherein when the transport device is at rest the weight is supported between the frame and wheels and when the second end of the frame is manually raised, the weight is supported only by the wheels.

2. A transport device comprising:
a frame defined by a first end and a second end and a length therebetween, the first frame end attached to an axle or more than one axle that connects to al least two wheels and the second frame end attached to a handle;
a first leg comprising a first end and an opposed second end;
a second leg comprising a first end and an opposed second end; and
an anchor point defined by an attachment configured to releasably attach to an item to be transported;
a support comprising a first end and a second end, the support positioned along the length of the frame, between the first leg and the handle;
wherein the first end of the first leg is attached to the frame along the length of the frame and the second end of the first leg is attached to the first end of the second leg;
wherein the anchor point is positioned adjacent to the second end of the second leg.

3. The kayak transport device of claim 2, wherein the first leg and the second leg are configured as a single element.

4. The kayak transport device of claim 2, wherein the frame comprises a top face and an opposed bottom face, and wherein the first end of the first leg is attached to the top face and the support is attached to the bottom face.

5. The kayak transport device of claim 2, wherein the support is rotatable between a first position that extends in a downward direction and a second position parallel with or contacting the bottom face of the frame.

6. The kayak transport device of claim 2, wherein the first end of the first leg is attached to the frame at an angle, and wherein the angle is adjustable between 40 and 110 degrees.

7. The kayak transport device of claim 2, wherein the first end of the first leg is attached to the frame at an angle of 60 degrees.

8. The transport device of claim 2, wherein the anchor point is configured to swivel.

9. The transport device of claim 2, wherein the positions of the first arm and second arm are configured to fold parallel with the frame.

10. The transport device of claim 2, wherein the anchor point is aligned between the first end of the first leg and the axle in a first at rest orientation and the anchor point is aligned over the axle in a second in use orientation.

11. The transport device of claim 10, wherein the handle is elevated in the second in use orientation.

12. The transport device of claim 2, wherein the at least two wheels are powered by a battery and motor.

13. A method of transporting an item having a weight using the transport device of claim 2, the method comprising:
positioning a first end of the item on a foundation comprising at least one wheel, wherein the foundation support a weight of the first end of the item;
attaching a second end of the item via an attachment point or item handle to the anchor point via the attachment as a first orientation;
elevating the handle, wherein the weight of the item is distributed over the transport device two or more wheels, foundation one or more wheels, and the frame in a second orientation;
wherein the item is transported from a first location to a second location using a pulling action by a user.

14. The method of claim 13, wherein the item is selected from a kayak, a canoe, or a watercraft.

15. The method of claim 13, wherein 100% of the weight of the item is distributed over the transport device two or more wheels, foundation one or more wheels, and frame.

16. The method of claim 13, wherein the support is rotated between a first position that extends in a downward direction in the first orientation and a second position parallel with or contacting the bottom face of the frame in the second orientation.

17. The method of claim 13, wherein the first end of the first leg is attached to the frame at an angle, and wherein the angle is adjustable between 40-100 degrees.

18. The method of claim 13, wherein the anchor point is configured to swivel.

19. The method of claim 13, wherein the anchor point is aligned between the first end of the first leg and the axle in the first orientation and the anchor point is aligned over the axle in the second orientation.

20. The method of claim 13, wherein the at least two wheels of the transport device are powered by a battery and motor.
